(19) United States
(12) Patent Application Publication
(10) Pub. No.: US 2006/0204321 A1
(43) Pub. Date: Sep. 14, 2006

(54) Photo album pages

(76) Inventor: Sharon Madsen, Ann Arbor, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/371,407

(22) Filed: Mar. 9, 2006

Related U.S. Application Data
(60) Provisional application No. 60/660,088, filed on Mar. 9, 2005.

(51) Int. Cl. B42F 13/00

(52) U.S. Cl. 402/79

(57) ABSTRACT

A photograph album page comprising a base sheet and a transparent plastic sheet secured to the base sheet. The transparent plastic sheet is approximately equal to or less than the size of the base sheet and is secured to the base sheet by stitching such that the base sheet and the plastic sheet cooperate to define a pocket into which a photograph can be removeably received.

### TECHNICAL FIELD

The present invention generally relates to photograph album pages.

### BACKGROUND

Photograph albums commonly provide a place where photographs may be conveniently stored, organized, and easily retrieved for display. Photograph albums are typically made up of a number of pages bound together to form a book. The book may be in the form of removable pages inserted into a separate binder (e.g., a 3-ring binder) or the pages may be permanently glued or otherwise bound together. In most albums, at least one photograph, or similar object, may be affixed to one or both sides of the page.

Photographs may be secured to album pages in a number of ways. A simple album page may consist of nothing more than a heavy sheet of paper or cardboard onto which photographs are affixed using either glue or adhesive tape. While often intended as being permanent, this has the disadvantage of being relatively insecure, while also making it difficult to move or change photographs once they have been secured. If the glue or tape happens to come loose, the photographs may fall out of the album and be lost. Another potential disadvantage is that there is nothing protecting the outer surface of the photographs from damage.

To address some of the aforementioned issues, some albums use a single sheet of clear plastic or a similar material to secure and cover the photographs after they are placed onto the page, which may then be covered with a pressure sensitive adhesive.

While this can protect the outer surface of the photographs, it does not prevent them from falling out of the album should the adhesive lose its tack. Other albums sometimes attach two plastic sheets along three edges of the sheets, using a bonding medium or plastic welding, to form one or more individual pockets on a page. This can eliminate the need to glue or tape the photographs to the page, since the photographs are inserted into the pockets, and the plastic protects the outer surface of the photographs. However, such a configuration can limit the arrangement of photographs on a page and may lack aesthetic appeal.

In view of the above, there exists a need to provide an improved means of securing photographs to an album page, while at the same time enhancing the page's aesthetic appeal.

### BRIEF DESCRIPTION OF THE DRAWINGS

FIG. 1 is a plan view of a photo album with a single album page with the pocket stitched directly to the album page.

FIG. 2 is an exploded view of an album page showing a pocket stitched to backing paper, which is in turn affixed to the album page.

### DETAILED DESCRIPTION

To address the above limitations, as well as overcoming certain potential drawbacks of the related art, the present invention provides an improved photograph album page. The page includes a clear plastic sheet stitched to a backing or page, thus forming a pocket. A photograph can be inserted or placed into the pocket and the entire assembly affixed either in the album or further to a base album page. The plastic and backing may be any size necessary to accommodate a variety of sizes of photographs. This allows photographs to be arranged and rearranged in a multitude of ways, while also, as optionally desired, providing an aesthetically pleasing layered look that can be incorporated into a photograph album or scrapbook.

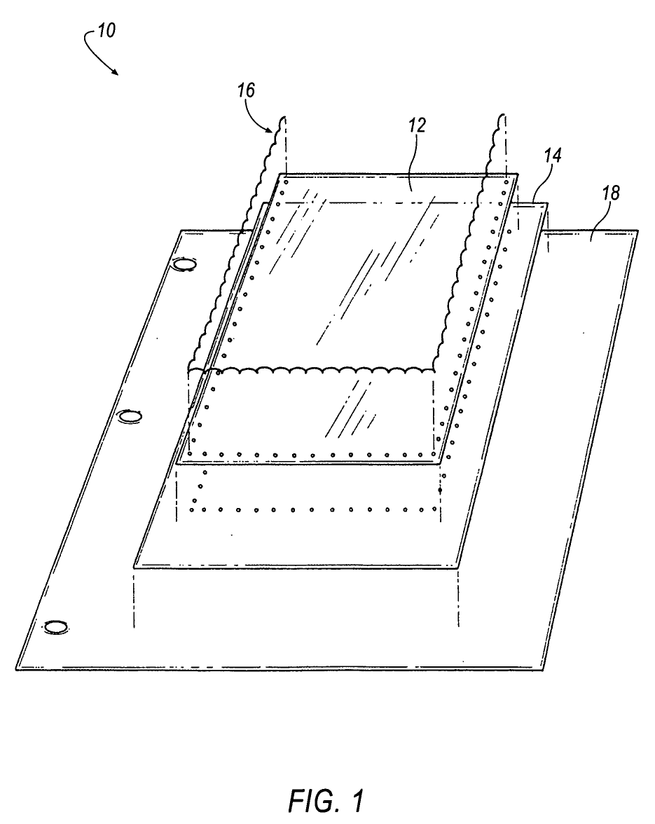

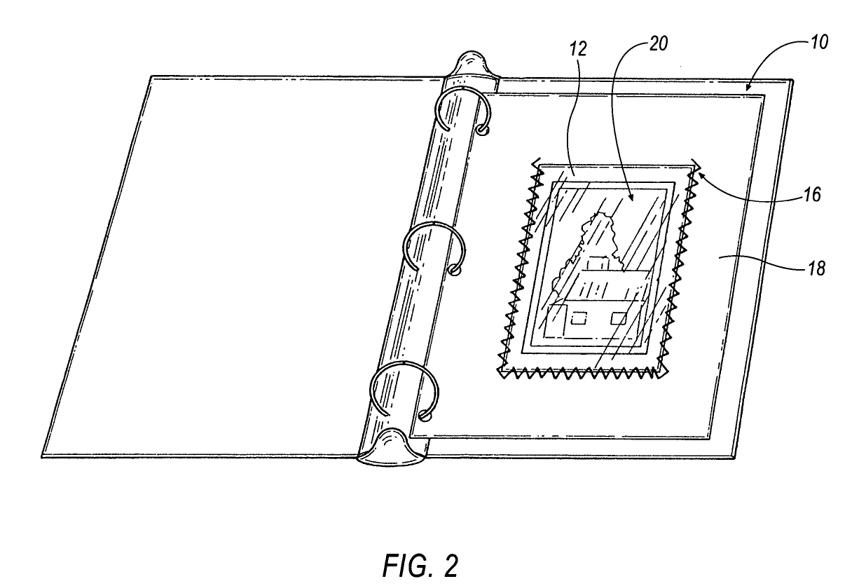

Referring to FIG. 1, an album page 10 according to an embodiment of the present invention is shown. A single sheet of clear or transparent plastic sheet 12 or similar material is attached to a backing 14. The backing may comprise a backing paper. The plastic sheet 12 is typically smaller in size (or no larger in square area) than the backing and is attached to the backing 14 by stitching 16. The stitching may comprise thread or similar material, and is present along at least one edge portion of the sheet, but not generally more than three edge portions of the sheet 12, i.e., to form a pocket or receiving portion and permit the insertion and retention of a photo. The stitching, which may, if desired, be continuous, may be of a conventional type and can be of any pattern desired. For example, the stitching may be done in a simple straight line, as generally shown in FIG. 1, or may take the form of more complex patterns, such as the zigzag stitch, as generally shown in FIG. 2. In an embodiment with stitching included on at least segments or three edge portions, the plastic sheet 12 and the backing 14 cooperate to form or define a pocket in which a photograph may be inserted, retained, and later removed. The backing 14 may then be connected or otherwise attached to a base page 18, for example, using glue or additional stitching. Further, the backing 14 may be the same or a different color from the base page, depending on the look desired.

In an another embodiment, the clear plastic sheets 12 may be stitched directly to the album page 18 without a backing and, as such, can form a pocket that will not come loose from the page 18. An illustrated example of such a second embodiment is shown in FIG. 2. Depending on the size of the plastic sheet 12, the pocket may be created or formed to any size necessary to accommodate a correspondingly sized photograph. This embodiment has the advantage of securing the photographs directly to the pages, while providing a stitched appearance. At least in part due to reduced use of glue and/or stitching, the simpler construction of the embodiment illustrated in FIG. 2 may provide certain economic advantages with respect to the embodiment illustrated in FIG. 1, while still providing a photo pocket that is securely attached to an album page, and while maintaining an aesthetically-pleasing appearance.

In light of the above description, with reference to the drawings that form a part of this specification, further objects, features and advantages of this invention will become apparent to persons skilled in the art, without departing from the scope of the invention.

What is claimed is:

1. A photograph album page comprising:
a backing; and
a transparent plastic sheet secured to the backing, the plastic sheet being approximately equal to or less than the size of the backing and being secured to the backing by stitching;
whereby the backing and the plastic sheet cooperate to define a pocket into which a photograph can be removeably received.

2. The album page as recited in claim 1, wherein the backing is non-transparent.

3. The album page as recited in claim 1, wherein at least a portion of the stitching is in a straight line.

4. The album page as recited in claim 1, wherein at least a portion of the stitching is in a zigzag pattern.

5. The album page as recited in claim 1, including a page, wherein the backing is connected or secured to the page.

6. The album page as recited in claim 5, wherein the backing is stitched to the page.

7. The album page as recited in claim 5, wherein the backing is a different color than the page.

8. The album page as recited in claim 1, wherein the stitching is comprised of thread.

9. The album page as recited in claim 1, wherein at least a portion of at least one edge portion of the plastic sheet is stitched to the backing.

10. The album page as recited in claim 1, wherein at least a portion of at least three edge portions of the plastic sheet are stitched to the backing.

11. A photograph album page comprising:
an album page; and
a transparent plastic sheet secured to the album page, the plastic sheet being approximately equal to or less than the size of the album page and being secured to the album page by stitching;
whereby a portion of the album page and the plastic sheet cooperate to define a pocket into which a photograph can be removeably received.

12. The album page as recited in claim 11, wherein at least a portion of the stitching is in a straight line or in a zigzag pattern.

13. The album page as recited in claim 11, wherein the stitching is comprised of thread.

14. The album page as recited in claim 11, wherein at a portion of at least one edge portion of the plastic sheet is stitched to the album page.

15. The album page as recited in claim 11, wherein at least a portion of at least three edge portions of the plastic sheet are stitched to the album page.

16. A method for making a photograph album page, comprising:
providing a backing;
providing a transparent plastic sheet that is approximately equal to or less than the size of the backing; and
stitching the backing and the plastic sheet together so as to define a pocket into which a photograph can be removeably received.

17. The method as recited in claim 16, wherein the backing is non-transparent.

18. The method as recited in claim 16, wherein at least a portion of one edge of the plastic sheet is stitched to the backing.

19. The method as recited in claim 16, wherein at a portion of three edges of the plastic sheet are stitched to the backing.

20. The method as recited in claim 16, wherein the backing is a page of an album and the plastic sheet is stitched directly to the page.
